(19) United States
(12) Patent Application Publication
(10) Pub. No.: US 2020/0145568 A1
(43) Pub. Date: May 7, 2020

(54) ELECTRO-OPTICAL IMAGER FIELD OF REGARD COVERAGE USING VEHICLE MOTION

(71) Applicant: Richard L. Vollmerhausen, Lake Mary, FL (US)

(72) Inventor: Richard L. Vollmerhausen, Lake Mary, FL (US)

(21) Appl. No.: 16/274,957

(22) Filed: Feb. 13, 2019

Related U.S. Application Data
(60) Provisional application No. 62/630,044, filed on Feb. 13, 2018.

(51) Int. Cl. H04N 5/232; G05D 1/00

(52) U.S. Cl. CPC H04N 5/2328; H04N 5/23296; G05D 1/0094

(57) ABSTRACT

An imaging device attached to an aerial vehicle for generating a plurality of images. The device comprises a plurality of successive optical elements terminating in an array of light sensitive elements, first mirror for controlling a line of sight in a vehicle pitch direction and for compensating changes in a vehicle pitch angle, first signals indicating a position of the first mirror about a pitch axis of the vehicle, second mirror stabilizing an image and removing image blur, position of the second mirror controlled by inertial data, second signals indicating a position of the second mirror, and the first and second signals input to processing components, also responsive to an output signal from the array of light sensitive components and to signals indicative of vehicle location, rotation and velocity, the processing components for generating the images and locating them in a 3-dimensional coordinate system.

### CROSS REFERENCE TO RELATED APPLICATION

The present application claims priority, under 35 U.S.C. 119(e), to the provisional patent application filed on Feb. 13, 2018, assigned application No. 62/630,044, and entitled Electro-Optical Imager Field of Regard Coverage Using Vehicle Motion, which is incorporated herein.

### FIELD OF THE INVENTION

The present invention relates to imaging a field of regard from an unmanned aerial vehicle (UAV) (also referred to herein as a drone and more broadly as an aircraft, all of which are used interchangeably herein) by using vehicle motion, instead of a gimbals set, to scan the imaging device over the field of regard, where the field of regard may contain an object of interest.

### OBJECT OF THE INVENTION

Modern imagers use staring arrays to achieve the best image sensitivity in the shortest frame time. Covering a large field of regard requires rapid slewing of the camera. The gimbals sets, as used in the prior art, slew the camera across the field of regard, but add weight, drag, and complexity on the UAV. The object of the present invention is to cover a large field of regard with a staring imager mounted on a UAV without use of a gimbals set, thereby lowering payload weight and drag, and providing longer UAV battery life.

### BACKGROUND DESCRIPTION OF THE PRIOR ART

As used in the present application, the field of regard (abbreviated FOR) is the total area to be captured by a movable sensor. FOR is distinguished from the field of view (FOV), which is the angular cone perceivable by the sensor (camera) at a particular time instant.

It is generally known that a gimbals set in a UAV/aircraft keeps the camera line of sight stable in space as the aircraft wiggles, rolls, turns, yaws, etc. Many UAV/aircraft motions are quite rapid and having general position information, such as GPS, is not sufficiently accurate to maintain a stable line of sight in space.

The use of electro-optical (EO) imagers on UAVs and drones has increased significantly in recent years. But the UAV or drone must carry the large and heavy existing electro-optical (EO) imagers. The UAV must also provide power to operate the EO imager. Additionally, a significant amount of the weight and power requirements are associated with the gimbals set that stabilizes and points the EO imager.

### BRIEF DESCRIPTION OF THE INVENTION

The present invention teaches a method and system for scanning a field of regard with a sensor (camera) mounted on a UAV/aircraft, that is, the UAV motion scans the field of regard. The line of sight is determined by motion of the UAV, such as rolls, turns, etc. A stabilization mirror in the optical system removes both jitter and motion blur. A head mirror, also in the optical system, operating about the pitch axis of the aircraft, implements FOR scanning, (e.g., in the pitch direction) while allowing the aircraft to maintain an efficient flight orientation. The position of the line of sight in a world-fixed coordinate system is known by the position of the mirror or mirrors in conjunction with the accelerometers, gyroscopes, and navigation system data that monitors aircraft location and orientation. Knowing the line of sight allows reconstruction of the images in a three-dimensional coordinate system.

The present invention provides state-of-the-art imaging performance for an Infrared Search and Track (IRST) application (or any application that requires scanning of a field of regard), while significantly lowering the weight, size, and power requirements of electro-optical systems deployed on UAVs, drones, or other aircraft.

None of the prior art taken individually or collectively discloses a method, and related system, for replacing the gimbals set on a UAV with the stabilization mirror and inertial sensing of the aircraft motion, thereby permitting the use of aircraft motion to scan a field of regard. Processing the collected data using digital processing software reconstructs images of the field of regard. According to the prior art, the gimbals inertially stabilize the image-gathering camera or sensor, and the gimbals line of sight is perturbed to scan the field of regard by pointing the camera/sensor.

Rather than mounting a sensor suite, comprising one or more imagers, on a gimbals set, which is then mounted to the UAV, this invention mounts the sensor suite to or in the airframe of the UAV. The invention further comprises a single axis head mirror (i.e., a mirror moveable about a single axis) that maintains the line of sight of the imaging device by operating in conjunction with aircraft motion while the UAV pitch changes as might be required to maintain an efficient flight profile. As is known by those skilled in the art, a head mirror directs the line of sight of the imaging device by changing the direction in which the objective lens is looking. However, the head mirror is not directly involved in the image capturing process, i.e., without a head mirror the imaging device can capture still images along its line of sight.

Blurred images, due to vibration of the UAV airframe and rapid airframe motion, must also be eliminated by the present invention. These effects are nulled using the stabilization mirror, which tends to move the LOS in an opposing direction to aircraft motion. The stabilization mirror is disposed in a collimated space in the optics path. The stabilization mirror removes the effects of aircraft motion on the image line of sight for a period of time, such as during and up to a frame time, i.e., a time during which the imaging device is capturing one image frame. In one embodiment this frame time is 1/60th of a second.

In addition to compensating for aircraft pitch maneuvers, the head mirror or stabilization mirror also provides image dither, if necessary, for efficient sampling. Generally, image dither moves the field of view one-half of a detector pitch to generate better image samples.

While the image data is collected, inertial data on airframe motion including roll, yaw, pitch, accelerometer data, as well as airframe position information is collected, time-stamped, and stored. The inertial data provides an accurate map of the pointed direction of the sensor suite line-of-sight at any instant of time. Angular position data of both the head mirror and stabilization mirror is also recorded during image collection. This data is required for accurately recreating the image in the field of regard.

Imagery is collected during a predetermined flight profile such that the camera (the imaging device) covers the field of regard in a pre-specified time. The airframe sweeps the sensor suite field of view over the field of regard, it being understood that the pointing may not necessarily always be precise. Gaps in field of regard coverage can be corrected by subsequent sweeps of the field of regard by the UAV.

The invention also incorporates digital processing algorithms to collate many frames of imagery into a wide-angle unified picture of the entire field of regard. Each image pixel in a frame has a known angular location within the field of view. The line of sight and angular tilt of the field of view is known from the inertial UAV position, angular rate and/or accelerometer data (i.e., position is acquired from integrating accelerometer and/or gyroscope rate data) and mirror position data collected simultaneously with the imagery. This data allows the image data from many frames to be combined and registered in an earth coordinate system.

Flying a predetermined flight plan, together with control of the head mirror and stabilization mirror, permits imaging of a predetermined field of regard. To reconstruct the field of regard image, the captured pixels are processed and placed in an earth-fixed coordinate system using the aircraft's inertial and orientation information (i.e., roll, pitch, yaw, accelerometer, and location data). The location data can be obtained from a GPS receiver or navigation system. The angular position of each image pixel is determined from accelerometer and gyroscope data, as well as mirror position data. Thus, the invention can create the image of a field of regard without use of a gimbals set as in the prior art.

### BRIEF DESCRIPTION OF THE DRAWINGS

The drawings described herein are for illustrative purposes only; the drawings are of selected embodiments, and not all possible apparatus configurations are shown. The drawings are not intended to limit the scope of the present disclosure.

The invention has the potential to be configured in multiple versions so as to generate superior technical performance in any given application. Therefore, it is understood that in some configurations not all elements will always be necessary for the specific embodiment or implementation of the invention. It should also be apparent that there is no restrictive one-to-one correspondence between any given embodiment of the invention and the elements in the drawing.

For clarity and in order to emphasize certain features, all of the invention features are not shown in the drawings, and all of the features that might be included in the drawings are not necessary for every specific embodiment of the invention. The invention also encompasses embodiments that combine features illustrated in the drawing; embodiments that omit, modify, or replace some of the features depicted; and embodiments that include features not illustrated in the drawing.

As used herein, relational terms, such as “first” and “second,” “top” and “bottom,” and the like, may be used solely to distinguish one entity or element from another entity or element without necessarily requiring or implying any physical or logical relationship or order between such entities or elements.

The drawings are integral to the application and are included by way of illustrating the invention apparatus.

FIG. 1 illustrates the major elements and mounting configuration of the invention, comprising a head mirror, afocal optics with a stabilization mirror, and a focal plane detector array.

FIG. 2 illustrates the invention mounted on a UAV for executing an Infrared Search and Track flight pattern to search for incoming aircraft.

FIG. 3 illustrates the invention field of view scanned over a target aircraft.

FIG. 4 illustrates the interconnection of the sensing, control, and data storage elements.

### DETAILED DESCRIPTION OF THE PREFERRED EMBODIMENTS

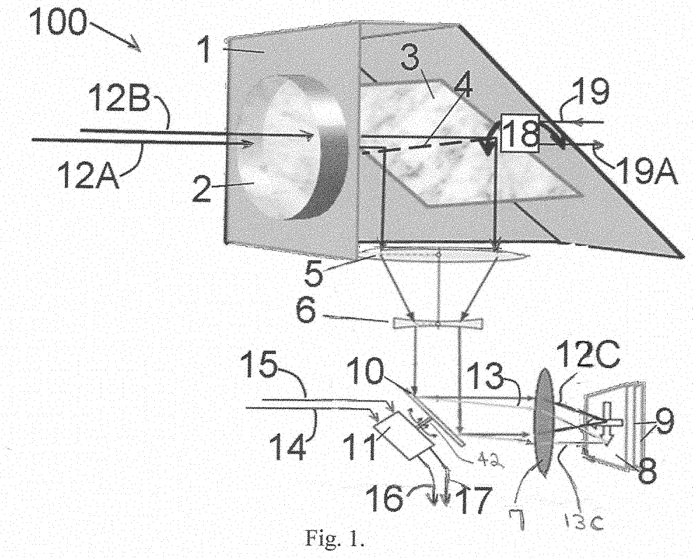

FIG. 1 illustrates an imager 100 within an enclosure 1 that protects imager components (also referred to as optical elements) from environmental damage as certain components of the imager 100 are mounted outside of an airframe (not illustrated). Other components may be alternatively mounted inside or outside of the airframe. Light rays 12A and 12B enter a window 2, are reflected or refracted through various optical components and are finally sensed by a photo detector array 8 within the imager. A head mirror 3 (also referred to as a pitch mirror) controls the pitch line of sight of the imager. Adjustment of the head mirror 3 during flight permits control of the airframe pitch without any effects on the LOS of the imager. Thus, this mirror allows the aircraft to fly an efficient flight profile, while navigating the airframe to scan over the entire field of regard. For example, for efficient flight it may be desirable for the aircraft to pitch up or down while turning left or right. The head mirror permits this aircraft pitch movement and compensates for it by maintaining the imager on the LOS so that the entire field of regard can be imaged. If the aircraft pitches up the mirror moves in the opposite direction to maintain imaging within the field of regard.

The mirror 3 rotates on an axis 4 driven by a mechanical drive 18 and directed by electrical signals 19 input to the mechanical drive 18. A resolver output signal 19A indicates an angle of the mirror 3, for example, about the pitch axis of the UAV/aircraft.

Lenses 5 and 6 form an afocal imager with infinity focus. Light rays exiting the lens 6 are parallel and therefore the line of sight of the imager can be changed without rotating the image. A lens 7 functions as an imager lens and focuses light on the photo detector focal plane array 8. Electrical outputs from the array 8 are amplified and processed by components disposed on, in one embodiment, electronic cards 9.

A mirror 10, disposed on an axis 42 and situated between the lens 6 and the lens 7 (see FIG. 1), stabilizes the image and cancels any motion during image capture. Mirror 10 allows image capture in a step stare fashion thereby avoiding motion blur as further described below.

When scanning a field of regard, the aircraft turns in one direction (horizontal left) for a period of time and then reverses course to scan the other direction (horizontal right). Thus, aircraft motion scans the field of view of the camera over the entire field of regard. Scanning in a vertical direction is accomplished by increasing/decreasing aircraft altitude or by moving the pitch mirror 3.

However, imagery captured during aircraft turns results in motion blur. To remove the motion blur, the mirror 10 scans the field of view in the direction opposite to the aircraft motion, where the signals 15 and 16 are input to a mirror control mechanism 11 that controls orientation of the axis 42 and thereby mirror orientation to provide the opposing mirror movement. At the end of a frame time ( 1/60^{th} of a second in one embodiment), the mirror 10 snaps back to an initial position and is ready to scan again during the next frame. That action is referred to as step stare or back scan. Note that the mirror 10 needs sufficient angular travel distance to effectively execute the step stare function.

The mirror 10 can also provide dither in order to improve sample spacing. That is, the mirror can be used to move imagery half a detector pitch between image readouts, thereby decreasing sample spacing and avoiding aliasing in the image.

The mirror 10 can also correct line of sight errors that arise because the airframe cannot be flown with the precision necessary to accurately sample the whole field of regard. That is, field of regard coverage is accomplished by correcting line of sight deviations using mirror 10 as well as turning the aircraft.

The position of the mirror 10 is mechanically controlled by the mirror control mechanism 11 as controlled by the electrical input signals 14 and 15, providing pitch and yaw position inputs, respectively. In one embodiment, other inertial data is also input to the mirror 10 via the electrical signals 14 and 15. Output signals 16 and 17 indicate the orientation of the mirror 10 for later use in reconstructing the image.

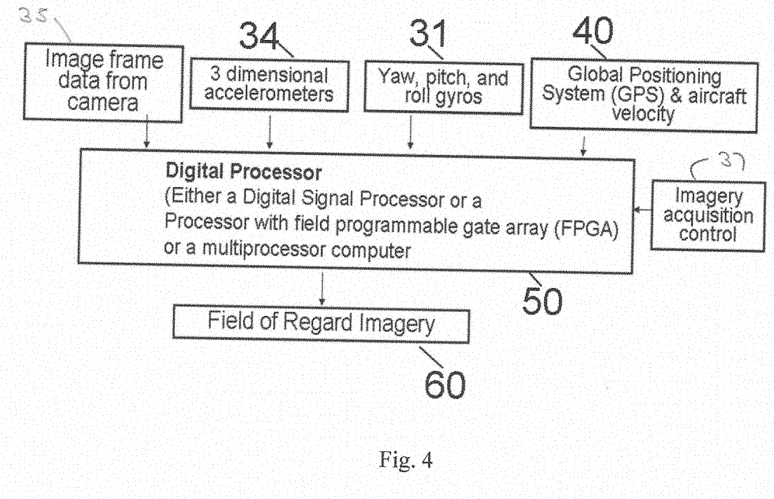

Support electronics, as further described in conjunction with FIG. 4, gathers inputs of pitch, yaw, roll of the airframe, position (angle) of the head mirror 10, position (angle) of the stabilization mirror 10, location and pointing direction of the aircraft, as well as aircraft velocity and acceleration in three dimensions. A processor, one element of the support electronics, calculates and saves the image data for the field of regard. Any region of the FOR that has been missed must be visited on subsequent scans of the UAV. To capture those missed regions, a subsequent UAV flight profile is calculated and the aircraft controlled accordingly.

All of these calculations and processing details are understood by those skilled in the art in the engineering community and delineating the details here is not necessary.

Aircraft roll affects the image capturing process. Aircraft roll, which may be required to maintain an efficient flight profile, rotates the image during image capture and therefore requires the head mirror 3 to assume different positions during the roll maneuver. Since the head mirror is frequently not pointing through the aircraft nose, roll has a significant effect on look direction of the imager. Generally, any aircraft motion that affects the look direction of the imager is needed to accurately construct the field of regard image.

Angular control of the field of view is illustrated by light rays 12A and 12B originating from a region directly forward of the airframe. With the mirror 10 in a centered, non-nutated position, the light rays 12A and 12B, after reflection and refraction by the imager optical elements, form the light ray 12C that strikes the center of the photo array 8. Rotating the mirror 10 slightly to change the field of view, re-directs the ray 12C to a path 13 for a light ray 13C.

As has been described, the mirror 10 has many functions, e.g. line of sight stabilization, step stare, and correcting position error of the aircraft.

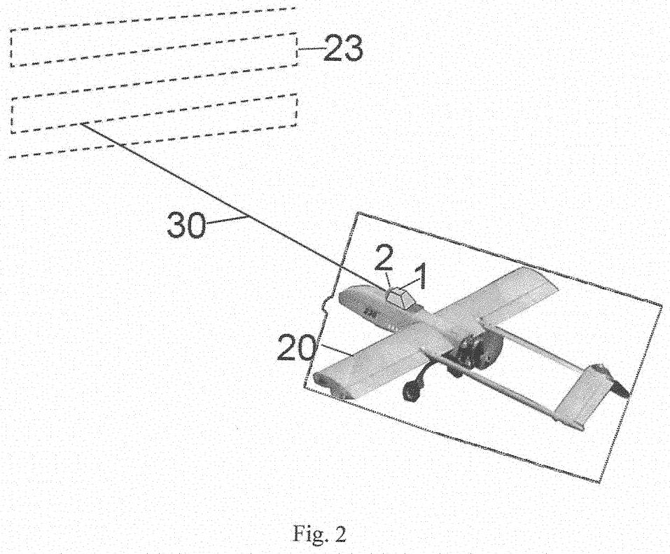

FIG. 2 illustrates a UAV 20 executing a flight profile such that the invention scans a field of regard 23. The enclosure 1 and the window 2 are shown as mounted on a top surface of the UAV 20 with the remainder of the components in FIG. 1 mounted inside the UAV airframe. Line of sight 30 is established by UAV position and orientation and the mirrors 3 and 10 of FIG. 1. The field of regard 23 is swept out by the UAV flight profile in combination with control of mirror angular positioning mechanisms within the imager 100.

As described elsewhere herein, one of the primary functions of the mirror 3 is to implement field of regard scanning without requiring the aircraft 20 to fly in inefficient or unattainable airframe orientations. The mirror 3 permits the aircraft 20 to fly with a pitch suitable for the flight profile while maintaining field of regard coverage.

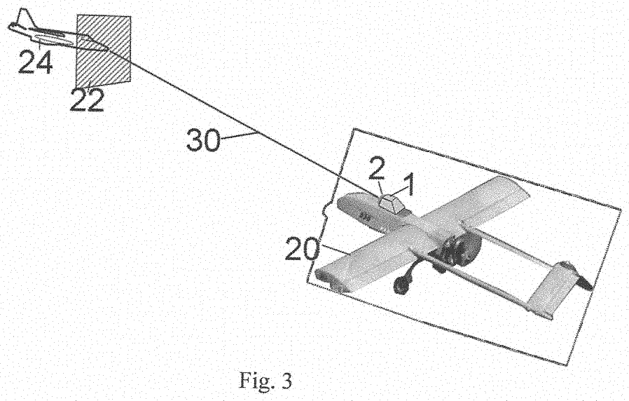

In FIG. 3, the field of view of the invention 22 intersects the flight path of a target airplane 24. By scanning the field of regard in such a manner, each point within the field of regard is swept by the field of view, thereby executing reliable imaging of the field of regard. In one application the FOR is swept to determine whether any aircraft are within the FOR.

See FIG. 4. Sufficient information is available to place the angular locations of the aircraft 20 of FIG. 3 and detected targets in the FOR in an earth-fixed coordinate system. The position of the UAV versus time is determined by the Global Positioning System or an inertial navigation system 40.

In addition, all mirror angles (i.e., angles of the head mirror 3 and the stabilization mirror 10) are known from the output signals 16, 17, and 19A (see FIG. 1).

The UAV yaw, pitch, and roll data is known from gyroscopes 31.

Accurate calculation of UAV position/orientation change is available by integrating and further processing signals from accelerometers 34 on the airframe (the integral of acceleration is velocity and the integral of velocity is position). With a known starting point, any changes in position/orientation are used to determine a current position/orientation. Also, an accurate location of the aircraft/imaging device in three-dimensional coordinate system is not as critical as detecting changes in position/orientation so that the imaging device can be rapidly pointed in the right direction. A GPS system, for example, provides fairly accurate position information, but not quickly enough as the aircraft moves and occasionally wiggles and wobbles. The accelerometer output signals are integrated to derive position as a function of time and updated quickly to provide more accurate and timely position/orientation information. Note that small movements of the aircraft are more important to secure an accurate image of the entire field of regard, than the long-term flight profile of the aircraft, the latter of which can be obtained from GPS or inertial navigation systems.

Image frame data 35 is supplied from one or more cameras or other sensors (IRST) mounted on the airframe.

An image acquisition control block 37 activates the imager as required and controls storage of the image frames.

As illustrated in FIG. 4, parameters from the various identified elements are input to a digital processor 50.

The detection of a target (e.g., an aircraft) within the field of regard occurs at the photo detector focal plane array 8. See FIG. 1. The field of view is known and the tilt and angular locations of the field of view within an earth-fixed coordinate system are also known. Processing executed by the digital processor 50 incorporates rapidly updated data on aircraft position and orientation as well as mirror pointing data for the mirrors 3 and 10. Therefore, the processor places all image pixel data in a registered image 60 of the field of regard 23.

The equations and coordinate transformations used to register image data collected in real time from the UAV into a unified and well aligned field of regard image are well known to those skilled in the image processing arts, and therefore details are not provided here.

Stabilization of the line of sight 30 in FIGS. 2 and 3 along with removal of scan motion in order to step stare across the field of regard involves using the rate gyro outputs 31 along with mirror positions as indicated by output signals 16, 17, and 19A. Again, mirror control involves processing and computations that are well known to those skilled in stabilization mechanisms and the details are not provided here.

What is claimed is:

1. An imaging device attached to an aerial vehicle for generating a plurality of images, the imaging device comprising:
a plurality of optical elements forming an optical path terminating at an array of light sensitive elements;
a first mirror within the optical path for controlling a line of sight of the imaging device about a pitch axis of the vehicle, the first mirror for compensating changes in a pitch angle of the vehicle;
first signals indicating a position of the first mirror about a pitch axis of the vehicle;
a second mirror within the optical path for at least one of stabilizing an image and removing image blur, position of the second mirror controlled by inertial data;
second signals indicating a position of the second mirror; and
the first and second signals input to processing components, the processing components also responsive to an output signal from the array of light sensitive components and responsive to signals indicative of location, rotation and velocity of the vehicle, the processing components for generating the images and locating each image in a 3-dimensional coordinate system.

2. The imaging device of claim 1 wherein the first mirror comprises a plane mirror.

3. The imaging device of claim 1 wherein the array of light sensitive elements comprises a photo detector array.

4. The imaging device of claim 1 the second mirror for stabilizing the image during a time required to image a frame.

5. The imaging device of claim 1 wherein a plurality of images forms a field of regard.

6. The imaging device of claim 1 wherein a duration of each image is 1/60^{th} of a second and the second mirror stabilizes an image during a 1/60^{th} of a second interval.

7. The imaging device of claim 1 wherein vehicle motion allows the imaging device to scan a field of regard.

8. The imaging device of claim 1 wherein changing an angle of the first mirror allows the imaging device to scan in a vertical or pitch direction relative to the pitch axis.

9. The imaging device of claim 1 wherein the aerial vehicle comprises an unmanned aerial vehicle.

10. The imaging device of claim 1 wherein inertial data comprises data responsive to roll, pitch, and yaw of the aerial vehicle.

11. The imaging device of claim 1 wherein the inertial data comprises parameters data from three-dimensional accelerometers.

12. The imaging device of claim 1 wherein the inertial data comprises data responsive to a location and velocity of the aerial vehicle.

13. The imaging device of claim 10 wherein the location is supplied by a global positioning system.

14. The imaging device of claim 1 wherein the processing components comprise a digital signal processor or a microprocessor

15. The imaging device of claim 1 wherein a position of the first mirror comprises an angle of the first mirror and a position of the second mirror comprises an angle of the second mirror.

16. The imaging device of claim 1 wherein the plurality of optical elements comprises a first and a second lenses forming an afocal imager and a focus lens, the first mirror disposed before the first lens, the second mirror disposed between the second lens and the focus lens, and the array of light sensitive elements disposed following the focus lens.

17. An imaging device attached to an unmanned aerial vehicle for generating an image of a field of regard, the imaging device comprising:
a plurality of optical elements forming an optical path terminating at a photo detector array;
a first plane mirror at a beginning of the optical path for controlling a line of sight of the imaging device in a pitch direction relative to the vehicle, the first plane mirror for compensating changes in a pitch angle of the vehicle;
first signals indicating an angle of the first plane mirror about a pitch axis of the vehicle;
a second mirror within the optical path for stabilizing an image during a frame time of 1/60^{th} of a second and for removing image blur, a position of the second mirror controlled by signals responsive to roll, pitch, yaw, and acceleration of the vehicle;
second signals indicating an angle of the second mirror; and
the first and second signals input to a digital signal processor or a microprocessor, the processing components also responsive to an output signal from the photo detector array and responsive to signals indicative of location, acceleration in three dimensions, roll, pitch, yaw, and velocity of the vehicle, the processing components for generating the image and for locating the image in a 3-dimensional coordinate system.

18. The imaging device of claim 17 wherein the location is supplied by a global positioning system.

19. The imaging device of claim 17 wherein the plurality of optical elements comprises a first and a second lenses forming an afocal imager and a focus lens, the first mirror disposed before the first lens, the second mirror disposed between the second lens and the focus lens, and the array of light sensitive elements disposed following the focus lens.

20. The imaging device of claim 17 for performing an infrared search and track (IRST) operation.
